(19) United States
(12) Patent Application Publication
(10) Pub. No.: US 2021/0259080 A1
(43) Pub. Date: Aug. 19, 2021

(54) Smart LED Driver having Smart Microcontroller for Lighting Applications

(71) Applicant: OPEN PLATFORM SYSTEMS LLC, Garden City, ID (US)

(72) Inventors: Dan Dina, Garden City, ID (US); Bob Deely, Garden City, ID (US)

(21) Appl. No.: 17/175,461

(22) Filed: Feb. 12, 2021

Related U.S. Application Data
(60) Provisional application No. 62/976,042, filed on Feb. 13, 2020.

(51) Int. Cl. H05B 45/50; H05B 47/175

(52) U.S. Cl. CPC H05B 45/50; H05B 47/175

(57) ABSTRACT

A smart driver for controlling an LED. The smart driver is configured with a power input, a control input configured for connection to a light controller, a DC power output configured to power an LED, and a smart microcontroller configured to control the DC power output to the LED in response to input from the light controller. The smart microcontroller is configured to dynamically adjust the control of the DC power output to the LED based on the control standard of a light controller connected to the light controller input. Preferably the smart microcontroller is configured to automatically detect the type of light control standard utilized by the light controller in order to automatically adjust DC power output to the LED in accordance to input of the light controller. The smart microcontroller in some embodiments can be configured remotely to recognize a specified light control standard based on a light controller connect or to be connected to the smart driver. The smart driver can further have an auxiliary DC power device output configured for connection to an auxiliary DC power device, such as a sensor. The smart microcontroller in some embodiments can be configured through the light control standard to dynamically adjust the auxiliary DC output to a sensor. Example sensors include environmental sensors, such as occupancy sensors and ambient light sensors, or internal luminaire sensors for sensing internal conditions of the luminaire, for example for detecting faults in the luminaire.

### PRIORITY/CROSS-REFERENCE TO RELATED APPLICATIONS

This application claims the benefit of U.S. Provisional Application No. 62/976,042, filed Feb. 13, 2020 the disclosure of which is incorporated by reference.

### TECHNICAL FIELD

The disclosure generally relates to the field of power control for lighting applications. Particular embodiments relate to a smart driver having a smart microcontroller for controlling power input and light output in one or more lighting devices and/or lighting systems.

### BACKGROUND

The typical Light Emitting Diode array (LED) AC/DC Power Conversion design contains AC input voltage, auxiliary DC output voltage, LED drive output and several control types including 0-10V, pulse width modulation, digital device interface and DALI/DALI2/D4i industry standards for connecting to a controller utilizing typically one of these standard control types. A controller according to one of these standard control types and other standard control types, whether currently in existence or in existence in the future, is herein referred to as a “light controller.” Based on the Applicant's knowledge, the state of the art today does not dynamically switch between these standards and usually these standards are implemented with different driver models. What is needed is a smart driver having a smart microcontroller capable of accepting varying standard control types through a common control line, including a wired control line or a wireless control line, and configured at installation, in the factory or the field that will minimize driver models or multiple control signal lines, and preferably being configured to detect the standard utilized by a light controller upon connection of the light controller to the common control line such that the smart microcontroller is configured to prompt an installer to approve of the recognition of the light controller or to automatically switch control of the output of the driver in response to new or different control standards and/or power input source(s).

### SUMMARY OF THE DISCLOSURE

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

In a preferred embodiment an intelligent driver is provided that is configured for the control of a luminaire. The intelligent driver has a power input, a DC power output configured to provide DC power to an LED, a control input configured for attachment to a light controller, and a smart microcontroller configured to efficiently and dynamically switch the DC power output in accordance with the control standard of a light controller connected to said control input. Preferably the smart microcontroller is configured to detect the control standard of a light controller that is connected to the control input and to automatically control the DC power output according to the control standard of the light controller detected. Preferably this occurs upon initial connection of the light controller to the control line of the smart driver.

In some embodiments, the smart microcontroller includes a safety control circuit configured to detect wiring that is not compatible with the control standard that is programmed into said smart microcontroller. Preferably the smart microcontroller is configured to recognize a new, different light controller has been connected to the smart driver and to automatically adjust control of the DC power output according to the new, different light controller. Typical control standards currently employed in the lighting industry include 0-10V, pulse width modulation, digital device interface and DALI/DALI2/D4i industry standards.

Preferably the intelligent driver includes a circuit configured for converting AC power from the power input to DC power. The Smart LED Driver can also be configured to utilize power from a DC source. Preferably the intelligent driver includes comprising a wireless or wired communication device to connect said smart microcontroller to at least one other microcontroller in a mesh network and to the Internet.

Preferably the intelligent driver has an auxiliary output. The auxiliary output is configured to provide DC power to an auxiliary DC device, such as a sensor. Preferably the smart microcontroller is configured to dynamically digitally regulate the output of the DC AUX power output based on input from a wired or wireless light controller.

The Smart LED Driver design makes use of its connectivity capabilities (wired or wireless) to allow control interface programmability at the time of installation in the factory, at a customer site, or elsewhere to allow for a single driver to be used whereas previously different drivers were required for different control standards. This novel design allows multiple interfaces to use the same physical connections on the Smart LED Driver in order to support several Digital and Analog control methods which by definition are usually mutually exclusive to each other. For example the Analog Dimming function requires a controller to present an Analog Voltage level between the IN+/IN− terminals of the Power Supply, which when sampled by the Power Supply interface circuitry provides an indication of the Diming level needed to control the Voltage/Current delivery to the load. In this mode the full range of Light output is comprised of a voltage level in the range of 0-10V which using visual logarithmic levels determine how much light output to generate out of the light fixture being powered by the Power Supply.

The same IN+/IN− pins or wireless light control can be programmed through the wireless interface in the Smart LED Driver design, to configure them to act as the digital interface (DA+/DA−) typically used by the industry standard Light Control interfaces such as DALI, DALI2, D4i and others. Similarly the smart microcontroller can be configured to recognize the light controller connected to the IN+/IN− pins and adjust and control the power supply to the light in accordance with the control type from the recognized controller.

By allowing commissioning and changing, preferably automatically, the control interface at time of installation, the Smart LED Driver design greatly reduces the clutter and expense of having to provide additional interface terminals for each Analog and Digital interface supported.

For example, when programmed for Digital Control interface standards the IN+/IN− lines will be pulled up to 10-12Vdc by the Control port circuitry meeting the requirements for the idle state of the Digital Interfaces mentioned above. External electronic switching elements will route signals to the proper input port where the smart microcontroller of the Smart LED Driver will detect Digital Control Communications and respond accordingly.

The Smart LED Driver may also incorporate safety protections circuitry that will allow detection of the Control Port to alert the Owner of the installation (such as through wireless mesh networking means described elsewhere in a separate patent disclosure) that wiring has changed and either approve or disable the fixture until human intervention in verifying the interface details is possible.

By using the Control Port programming feature described in this disclosure, the Smart LED Driver will present to the user a very clean interface as shown, using programmable technology to eliminate the clutter as well as error in installation that could occur due to multiple Control Interfaces being present on the device.

Often accessory devices such as occupancy sensors are needed in LED light fixtures. These devices often use different input voltages. The smart microcontroller capability of this invention in preferred embodiments allows the dynamic switching of the AUX output lines to support different DC power supply accessories. Preferably the smart microcontroller is configured to automatically detect the type of DC power supply accessory connected to the smart microcontroller in order to automatically dynamically switch the AUX output lines to support the specific DC power supply accessory.

An additional feature of the programmability, monitoring and change of functionality proposed by this Patent disclosure is that the Power Supply will be made virtually immune from installation error.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF THE DRAWINGS

FIG. 1 illustrates a preferred embodiment of a wiring schematic of a driver of a luminaire.

FIG. 2 illustrates the block diagram of the Smart LED Driver with input and output identified.

### DETAILED DESCRIPTION OF THE PREFERRED EMBODIMENTS

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

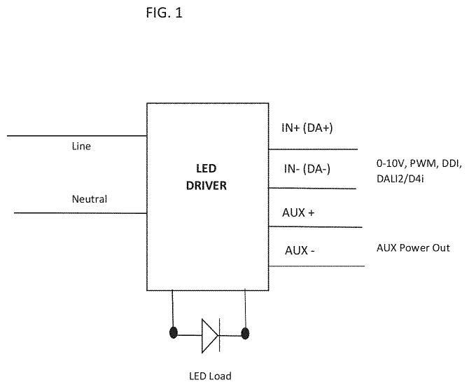

FIG. 1 illustrates a preferred embodiment of a LED driver configured with a control interface (shown by IN+(DA+) and IN−(DA−) ports. The LED driver utilizes a smart microcontroller. The depicted embodiment includes an AC power source (shown by line and neutral inputs), although the Smart LED Driver can be configured for operation from a DC power source. An auxiliary output is shown for connection to a DC auxiliary power supply accessory, such as but not limited to, environmental sensors such as an occupancy sensor or an ambient light sensor, or internal sensors of the luminaire. The smart microcontroller is configured to adjust to operation of the driver depending on the light controller connected to the Smart LED Driver. Preferably the smart microcontroller is configured to automatically identify the light controller connected to the LED driver upon connection of the Smart LED Driver to the light controller. This allows the smart microcontroller to control the DC power, shown as LED load in FIG. 1, supplied to the LED light based on the control input from the light controller. The ability of the smart microcontroller to recognize the light controller attached to it, and/or for remote configuration of the smart microcontroller and Smart LED Driver depending on the light controller attached or to be attached.

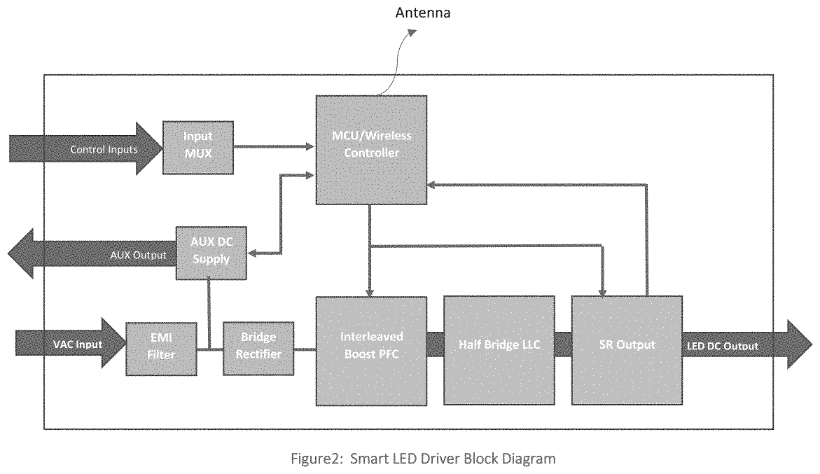

FIG. 2 illustrates a preferred embodiment of a Smart LED Driver according to the inventive concepts disclosed herein. The Smart LED Driver has an AC power input (labeled VAC Input), and EMI filter for filtering electromagnetic interference, and a bridge rectifier for converting AC power to DC power. DC power for powering the LED then passes through a DC power output, shown in the diagram with an Interleaved Boost Power Factor Correction (PFC), a Half Bridge LLC, and a Set-Reset (SR) Output for regulating the DC power provided to the LED. A smart microcontroller is configured to regulate the DC power supplied to the LED by regulating the power distribution through the DC power output. The smart microcontroller is configured to regulate the DC power output in response to a control signal from a control input that is connected to a light controller. The smart microcontroller is preferably configured to recognize the control standard of the light controller connected to the control input and to adjust regulation of the DC power output in response to control from the smart microcontroller.

The smart microcontroller is configured to further regulate power output to an AUX DC Supply to an AUX Output. The AUX Output is configured for connection to an auxiliary DC device, such as a sensor as discussed above. The smart microcontroller is preferably configured to dynamically regulate the power output to the AUX DC Supply, preferably based on the type of device attached to the AUX output. In the depicted embodiment the smart microcontroller is connected to a wireless module that is configured to connect to a local mesh network, other devices over wireless networks such as Bluetooth, to a router or similar gateway to the internet or other network, and/or direct to the internet via an integrated router.

While certain preferred embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

What is claimed is:

1. An intelligent driver configured for the control of a luminaire, said intelligent driver comprising:
a power input;
a DC power output configured to provide DC power to an LED;
a control input configured for attachment to a light controller;
a smart microcontroller configured to efficiently and dynamically switch the DC power output in accordance with the control standard of a light controller connected to said control input.

2. The intelligent driver of claim 1, wherein said smart microcontroller is configured to detect the control standard of the light controller connected to said control input and to automatically control the DC power output according to the control standard of the light controller detected.

3. The intelligent driver of claim 1, wherein said smart microcontroller comprises a safety control circuit configured to detect wiring that is not compatible with the control standard that is programmed into said smart microcontroller.

4. The intelligent driver of claim 1, wherein said smart microcontroller detects different control standards selected from the group consisting of 0-10V, pulse width modulation, digital device interface and DALI/DALI2/D4i industry standards.

5. The intelligent driver of claim 1 further comprising a circuit configured for converting AC power from said power input to DC power.

6. The intelligent driver of claim 1 further comprising a wireless or wired communication device to connect said smart microcontroller to at least one other microcontroller in a mesh network and to the Internet.

7. The intelligent driver of claim 1, wherein said driver comprises an auxiliary output, wherein said smart microcontroller is configured to dynamically digitally regulate the output of said DC AUX power output based on input from a wired or wireless light controller.

8. The intelligent driver of claim 1, wherein said DC power output is connected to an LED.
